(19) United States
(12) Patent Application Publication
(10) Pub. No.: US 2026/0159101 A1
(43) Pub. Date: Jun. 11, 2026

(54) GENERATIVE ARTIFICIAL INTELLIGENCE-BASED AUTONOMOUS DRIVING SIMULATION APPARATUS

(71) Applicant: ELECTRONICS AND TELECOMMUNICATIONS RESEARCH INSTITUTE, Daejeon (KR)

(72) Inventors: MYUNGWOOK PARK, Daejeon (KR); Ki Tae Kim, Daejeon (KR); JINWOO KIM, Daejeon (KR); Yoo-Seung Song, Daejeon (KR); KYOUNG HWAN AN, Daejeon (KR); MyungIn Ji, Daejeon (KR)

(21) Appl. No.: 19/395,394

(22) Filed: Nov. 20, 2025

(30) Foreign Application Priority Data
Dec. 10, 2024 (KR) 10-2024-0182953

(51) Int. Cl. B60W 50/02; B60W 50/00; B60W 60/00; G06F 30/15; G06F 30/27

(52) U.S. Cl. CPC B60W 50/0205; B60W 60/00; G06F 30/15; G06F 30/27; B60W 2050/0083; B60W 2420/403; B60W 2554/404; B60W 2555/20; B60W 2556/40; B60W 2556/45

(57) ABSTRACT

Disclosed is a technology which generates a virtual environment similar to a driving environment in a simulation environment by using generative artificial intelligence (AI) technology and develops, verifies, and evaluates an autonomous driving system through a complicated scenario in generated various environments.

### CROSS-REFERENCE TO RELATED APPLICATION

This application claims the benefit of the Korean Patent Application No. 10-2024-0182953 filed on Dec. 10, 2024, which is hereby incorporated by reference as if fully set forth herein.

### BACKGROUND

### 1. Field of the Invention

The present disclosure relates to technology which generates a virtual environment similar to a driving environment in a simulation environment by using generative artificial intelligence (AI) technology and develops, verifies, and evaluates an autonomous driving system through a complicated scenario in generated various environments.

### 2. Description of Related Art

As artificial intelligence (AI) technology is applied, autonomous driving technology has been developed quickly, but autonomous driving vehicles are difficult to drive in all driving environments. Continuous tests in complicated road environments, weather conditions, and road situations are needed for more enhancing the performance of an autonomous driving system, but tests on such environments and situations may have limitations in time and space and may not be ensured in safety, and system development and repeated experiments for verification are impossible. To this end, a real environment has been simulated in a virtual environment, and the recognition, determination, control function verification, and evaluation of an autonomous driving system have been performed through a simulation. However, an autonomous driving simulation method of the related art may not simulate all of a real environment. Because most manual operations are performed for modeling a virtual environment, much cost and time are consumed, and in an autonomous driving system recognition sensor, a distortion phenomenon occurs due to a physical characteristic, but it is difficult to model a distortion phenomenon of a sensor in a virtual environment. The reason is because it is difficult to perform physical modeling of a bad weather environment such as rain/snow/fog in a virtual environment, and thus, a recognition sensor in a virtual environment generates only ideal sensor data by using ground truth (GT) data in a simulation. Also, a movement path, a velocity, and traffic light in a signal crossroad should be manually designated for each object needed for a scenario for generating an autonomous driving scenario, and in a road environment (construction section, obstacle, etc.), only when there is a physical model, an autonomous driving system test is possible. However, all situations capable of occurring in the real driving environment described above are modeled in a virtual environment, and an autonomous driving system is verified through a simulation, and in this case, much cost and time and many labor personnels are required.

That is, in an autonomous driving simulation environment of the related art, it is difficult to accurately and physically reproduce various complicated factors such as a road environment, a weather condition, and a road situation, and particularly, most factors of a weather condition such as a bad weather situation provide only a visual effector and does not satisfy a physical factor. Also, autonomous driving recognition sensor data mainly provide data of a normal environment also, and even when it is possible to provide sensor data on a bad weather environment, only camera recognition information is provided, and LiDAR data and radar data are not provided, or only data which is inaccurate and is low in reality is provided. Also, in terms of a scenario for verifying and evaluating functions of an autonomous driving system, diversity is insufficient, and much time and cost for generating a complicated and detailed scenario are consumed.

The above descriptions are for helping understand the background of the inventive concept, and thus, may not be understood as descriptions corresponding to the prior art known to those skilled in the art.

### SUMMARY

The present disclosure is solving the problems described above and is for providing a method which may generate a physical virtual environment on various road environments, weather conditions, and road situations by using generative AI technology, may provide recognition sensor data based on the virtual environment to facilitate the development of an autonomous driving system in various environments, and may generate various complicated scenarios to secure the performance enhancement and reliability of the autonomous driving system.

The objects of the present invention are not limited to the aforesaid, but other objects not described herein will be clearly understood by those skilled in the art, based on descriptions below.

The present disclosure provides a generative artificial intelligence (AI)-based autonomous driving simulation apparatus. The generative AI-based autonomous driving simulation apparatus includes: a driving environment generator configured to generate a driving environment by using a pre-learned driving environment generating model, based on input driving environment information; a scenario generator configured to generate a scenario representing a change in the driving environment and an action of an object on a road over time by using a pre-learned scenario generating model, based on input scenario information; a virtual environment generator configured to visually and physically model the driving environment and the scenario to generate a virtual environment, based on the driving environment, the scenario, and a high-precision map; a simulation vehicle unit configured to drive in the virtual environment and generate vehicle driving information, based on a driving control signal; a sensor data generator configured to generate raw sensor data detected by a recognition sensor of the simulation vehicle unit in the virtual environment; and an autonomous driving system configured to generate the driving control signal to control driving of the simulation vehicle unit in the virtual environment, based on the raw sensor data and the vehicle driving information.

The present disclosure provides another embodiment of a generative artificial intelligence (AI)-based autonomous driving simulation apparatus. The generative AI-based autonomous driving simulation apparatus includes: a memory configured to store one or more instructions; and a processor configured to execute the one or more instructions, wherein, when a corresponding instruction is executed, the processor generates a driving environment by using a pre-learned driving environment generating model, based on input driving environment information, generates a scenario representing a change in the driving environment and an action of an object on a road over time by using a pre-learned scenario generating model, based on input scenario information, visually and physically models the driving environment and the scenario to generate a virtual environment, based on the driving environment, the scenario, and a high-precision map, generates vehicle driving information while driving in the virtual environment, based on a driving control signal, generates raw sensor data detected by a recognition sensor of the simulation vehicle unit in the virtual environment, and generates the driving control signal to control driving of the simulation vehicle unit in the virtual environment, based on the raw sensor data and the vehicle driving information.

Embodiments of the present disclosure provides a method which may construct a generative model through learning on various road environments, weather and climate conditions, and driving situations by using generative AI technology and may generate a physical virtual environment, based on text and image information input based on the model.

Moreover, embodiments of the present disclosure may implement raw sensor data of a sensor from a generated virtual environment by using AI technology and may generate various complicated scenarios to secure the performance enhancement and reliability of an autonomous driving system.

Moreover, embodiments of the present disclosure may reduce time and cost for generating a simulation environment, may simulate various driving environments such as weather and climate environments and road environments to be similar to a real environment so as to enable a physical interaction, and may provide sensor data similar to data detected from the real environment, and thus, may expect to enhance a recognition function and may provide a scenario of various driving situations in various complicated environments by using AI technology, thereby increasing the performance and driving-enabled area of an autonomous driving vehicle.

An effect capable of being obtained in the present disclosure is not limited to the effects described above, and other undescribed effects may be clearly understood by those skilled in the art, based on descriptions below.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 illustrates an example of a text-based model learning method for generating a driving environment.

FIG. 2 illustrates an example of a text input for learning a rainy environment and an example of the kind of climate and weather.

FIG. 3 illustrates an example of the kind of road state and an example of a text input for learning a road status.

FIG. 4 illustrates a functional configuration of a generative AI-based autonomous driving simulation apparatus.

FIG. 5 illustrates a configuration of a driving environment generator.

FIG. 6 illustrates an example of a method of inputting a text to a weather and climate environment generating module for generating a weather and climate environment.

FIG. 7 illustrates an example of a method of inputting a still image and a moving image to a weather and climate environment generating module for generating a weather and climate environment.

FIG. 8 illustrates an example of a method of inputting a cloud-based weather information request to a weather and climate environment generating module for generating a weather and climate environment.

FIG. 9 illustrates an example of a method of inputting an image to a road environment generating module for generating an environment.

FIG. 10 illustrates a configuration of a scenario generator.

FIG. 11 illustrates an example of generating a scenario through a map-based text input.

FIG. 12 illustrates an example of generating a scenario through an image and text input.

FIG. 13 illustrates an example of generating a scenario through a voice input.

FIG. 14 illustrates a configuration of a virtual environment generator.

FIG. 15 illustrates a configuration of a sensor data generator.

FIG. 16 is a block diagram illustrating a generative AI-based autonomous driving simulation apparatus according to an embodiment of the present disclosure.

### DETAILED DESCRIPTION OF THE INVENTION

Reference will now be made in detail to the exemplary embodiments of the present disclosure, examples of which are illustrated in the accompanying drawings. Wherever possible, the same reference numbers will be used throughout the drawings to refer to the same or like parts.

The terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way. The suffix “module” and “unit” of elements used herein may be assigned or used based on only the easiness of description and may not be differentiated from each other. The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that although the terms including an ordinary number such as first or second are used herein to describe various elements, these elements should not be limited by these terms. These terms are only used to distinguish one element from another element. For example, a first element may be referred to as a second element without departing from the spirit and scope of the present invention, and similarly, the second element may also be referred to as the first element.

In the case in which a component is referred to as being “connected” or “accessed” to other component, it should be understood that not only the component is directly connected or accessed to the other component, but also there may exist another component between the components. On the other hand, in the case in which a component is referred to as being “directly connected” or “directly accessed” to other component, it should be understood that there is no component therebetween.

The terms of a singular form may include plural forms unless referred to the contrary.

The meaning of ‘comprise’, ‘include’, or ‘have’ specifies a property, a region, a fixed number, a step, a process, an element and/or a component but does not exclude other properties, regions, fixed numbers, steps, processes, elements and/or components.

A video or an image according to an embodiment of the present disclosure may include a still image and a moving image unless there is a special limitation.

Hereinafter, embodiments of the present disclosure will be described in detail with reference to the accompanying drawings.

To generate data needed for a simulation of an autonomous driving vehicle by using generative AI, a model may be trained through learning. A model training process may generally include steps such as data collection, preprocessing of collected data, model construction, model training/evaluation, model optimization, and model improvement.

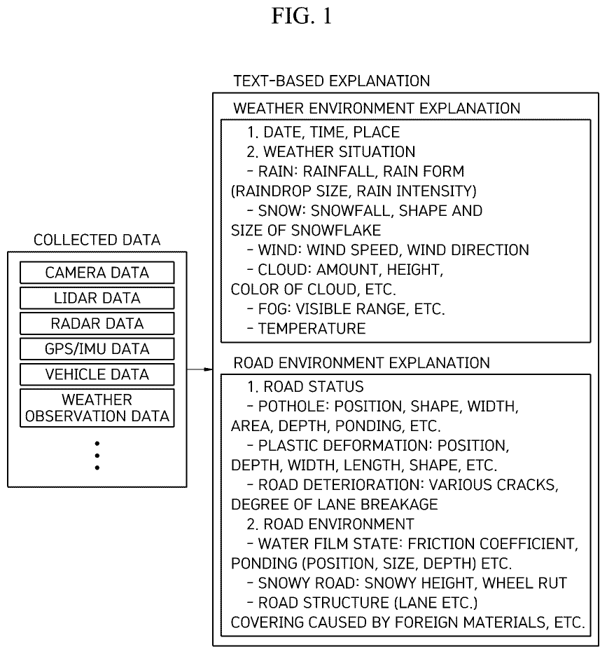

FIG. 1 illustrates an example of a text-based model learning method for generating a driving environment.

Referring to FIG. 1, the text-based model learning method may collect data of a camera, LiDAR, radar, a global positioning system/inertial measurement unit (GPS/IMU), a vehicle internal sensor, and an additional weather sensor, which are representative sensors used in an autonomous driving system, and may perform a preprocessing process such as the normalization and noise removal of each of sensors, and then, may perform learning by using a generative model.

Data collected from each sensor may include still image and moving image data when a sensor is a camera sensor, point cloud data including intensity information when a sensor is LiDAR (four-dimensional (4D) LiDAR), and extracted parameter data and intensity of a reflected signal when a sensor is radar (including 4D imaging radar). Furthermore, there may be GPS/IMU data, weather observation sensor data, and vehicle data.

To generate a virtual environment and sensor data desired in a simulation, learning in training of a generating model may be performed through text-based explanation. Also, learning of a road environment may perform learning by extracting only a specific portion such as a pothole, a road breakage portion so as to increase a degree of completion of learning.

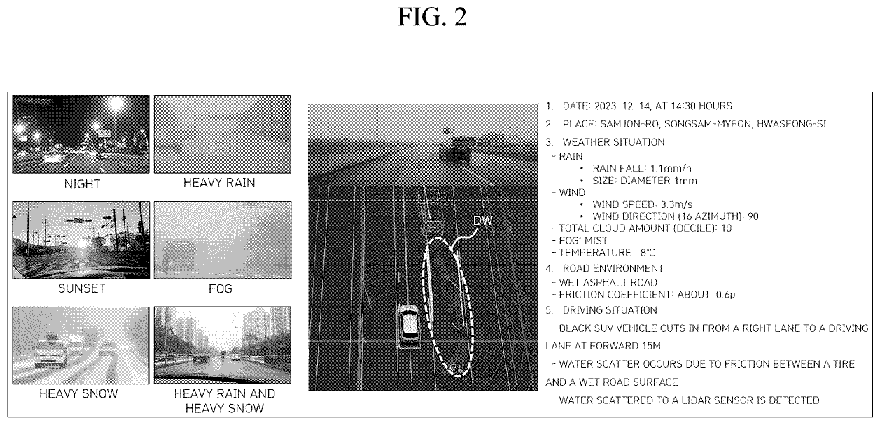

FIG. 2 illustrates an example of a text input for learning a rainy environment and an example of the kind of climate and weather.

In FIG. 2 (a), as an example of various climate and weather environments such as night, sunset, heavy rain, fog, heavy snow, as illustrated, in a climate and weather condition, an environment may be variously and complexly configured. Also, in FIG. 2 (b), as an example of text-based learning in a heavy rain environment, as illustrated, various information associated with the heavy rain environment may be input to a model for learning of a generating model, and a simulation environment may be generated by inputting, as a text, information about a driving situation such as explanation of detection of dispersed water particles caused by a friction as well as a weather situation and a road environment, thereby increasing the performance of a model through learning of the model based on the information about the driving situation. The information about the driving situation may include a place, the weather situation, and the road environment. In FIG. 2 (b), an upper photograph may be an example of an image of a vehicle which is driving in a front region on a real road when it heavily rains, and a lower photograph may be an example of a LiDAR image of the same situation.

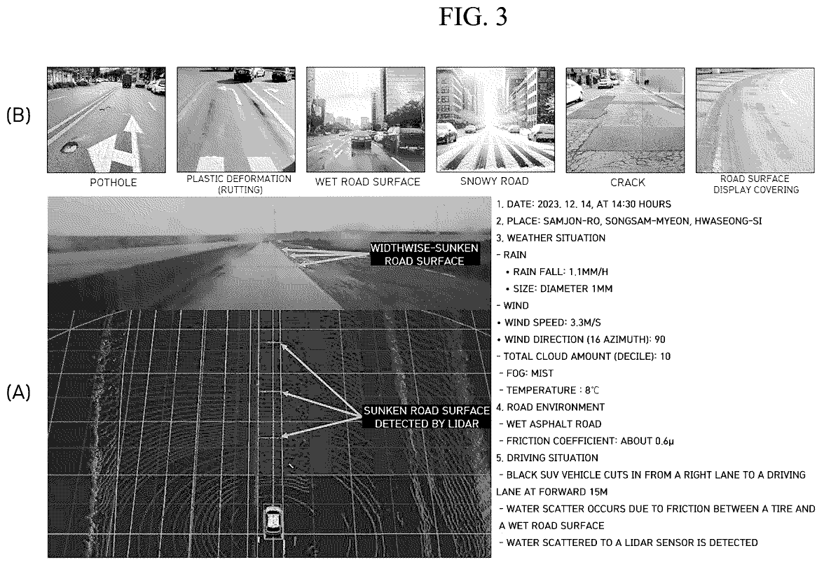

FIG. 3 illustrates an example of the kind of road state and an example of a text input for learning a road status.

FIG. 3 (a) illustrates an example of various road statuses, and FIG. 3 (b) illustrates an example of text-based learning on a road status, and as illustrated, a weather situation and widthwise-sunken road status information may be input. In an embodiment of the present disclosure, learning may be performed by emphasizing a position and a depth of a widthwise-sunken portion and sensor (camera and LiDAR) detection information, and thus, a simulation environment similar to a real environment may be generated. In FIG. 3 (b), an upper photograph may be an example of an image of a road having a widthwise-sunken road surface of a front region with respect to a driving vehicle, and a lower photograph may be an example of a LiDAR image of the same situation.

The autonomous driving simulation method performed by a generative AI-based autonomous driving simulation apparatus according to an embodiment of the present disclosure may realistically reproduce various complicated driving environments such as various road environments, weather conditions, and road situations by using generative AI and may provide raw sensor data of a driving environment recognition sensor detecting the environment in real time, and moreover, may generate a scenario capable of occurring in a real environment, based on test and image inputs.

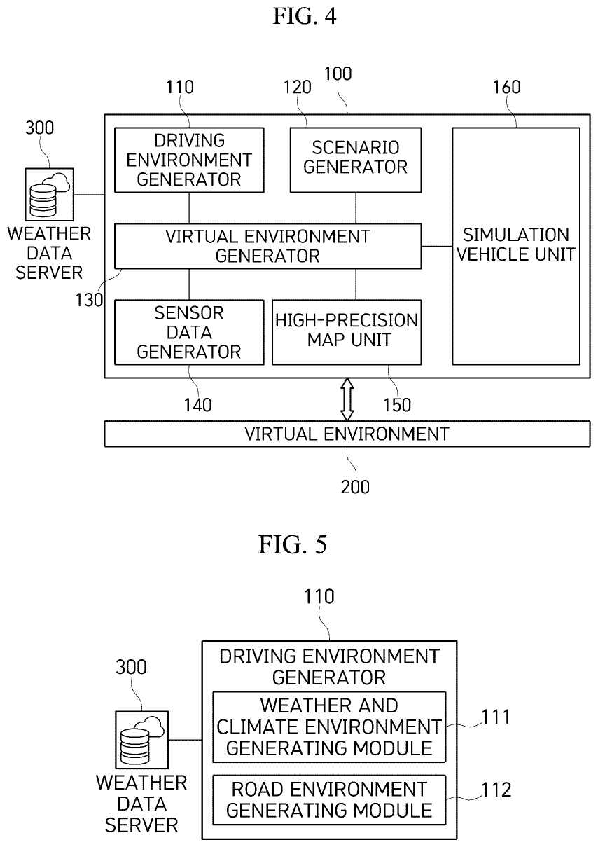

FIG. 4 illustrates a functional configuration of a generative AI-based autonomous driving simulation apparatus 100.

Referring to FIG. 4, the generative AI-based autonomous driving simulation apparatus 100 may be configured to include a driving environment generator 110, a scenario generator 120, a virtual environment generator 130, a sensor data generator 140, a high-precision map unit 150, and a simulation vehicle unit 160, so as to perform a generative AI-based autonomous driving simulation function. The illustrated elements may not be essential, and thus, a generative AI-based autonomous driving simulation apparatus including more elements or fewer elements may be implemented. Such an element may be implemented with hardware or software, or may be implemented by a combination of hardware and software.

The driving environment generator 110 may generate a driving environment such as a road environment, a weather condition, and a road situation. A driving environment may be generated through a driving environment generating model, based on driving environment information such as a text and image information input by a user or information received from a weather data server 300. The driving environment generating model may include a weather/climate generating model and a road environment generating model. The weather/climate generating model may generate weather/climate environment-related data as a driving environment, and the road environment generating model may generate road environment-related data as a driving environment.

The scenario generator 120 may generate various kinds of objects on a road by using a generative AI model which is trained to generate a scenario associated with a change in driving environment, based on input scenario information, may generate an action or a movement of each of the objects, may perform a function of generating a scenario representing a change in driving environment including a change in road environment and weather/climate environment over time.

The virtual environment generator 130 may visually and physically model a driving environment and a scenario by using information generated by the driving environment generator 110 and the scenario generator 120, and thus, may obtain data in each recognition sensor of an autonomous driving system.

The sensor data generator 140 may provide raw data (hereinafter referred to as raw sensor data) based on a situation by using data learned under various weather and physical conditions, and thus, may enable the autonomous driving system to independently perform development and verification without being limited to a time and a place.

The high-precision map unit 150 may be used for the purpose such as a conventional simulator and may provide a high-precision map to the virtual environment generator 130.

The simulation vehicle unit 160 may be referred to as an ego-vehicle and may be a virtual autonomous driving vehicle. The simulation vehicle unit 160 may operate according to a command such as the longitudinal/lateral control, brake control, or acceleration control of the autonomous driving system 200 in a simulation and may provide dynamic factor information about a vehicle, and driving data of a vehicle which drives based on a control command of the autonomous driving system 200 may be used in learning of the autonomous driving system 200 again.

The autonomous driving system 200 may control a dynamic factor of a vehicle such as performing the longitudinal/lateral control, brake control, or acceleration control of the autonomous driving system 200 in a virtual simulation environment generated by the autonomous driving simulation according to an embodiment and may be configured to include a recognition module, a determination module, and a control module (not shown). This may be the same as a conventional autonomous driving system.

Hereinafter, each element configuring the generative AI-based autonomous driving simulation apparatus 100 according to an embodiment will be described in detail with reference to FIGS. 5 to 15.

FIG. 5 illustrates a configuration of a driving environment generator 110.

Referring to FIG. 5, the driving environment generator 110 may be a driving environment generating model and may be configured to include a weather and climate environment generating module 111 and a road environment generating module 112. The illustrated elements may not be essential, and thus, a driving environment generator including more elements or fewer elements may be implemented. Such an element may be implemented with hardware or software, or may be implemented by a combination of hardware and software.

The weather and climate environment generating module 111 may generate weather/climate environment-related data, based on an information input of the weather data server 300 or text and image information input based on a pre-learned generative AI-based weather/climate generating model. The kind of weather capable of being generated through a pre-learned weather/climate generating model may include heavy rain, heavy snow, fog, illumination, clear, cloudy, and yellow dust, and a complex situation thereof.

The road environment generating module 112 may generate road environment-related data, based on text and image information input based on a pre-learned generative AI-based road environment generating model.

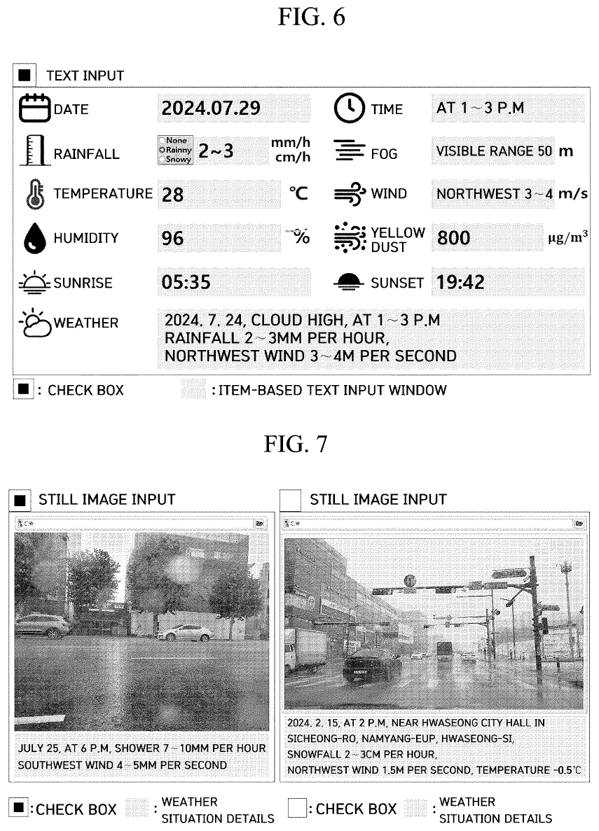

FIG. 6 illustrates an example of a method of inputting a text to a weather and climate environment generating module for generating a weather and climate environment.

In FIG. 6, a text input method for generating a weather environment and generating a climate environment is illustrated. A prompt input may be very important for generating data having high-level completion through a generative AI model, and thus, an operation of selecting various items to provide to a model may be effective for generating data. Therefore, as illustrated, a weather and climate generating module may provide a user interface associated with prompt and may provide a simple and consistent input environment, based on various input items (for example, date information, time information, rain information, fog information, temperature information, wind information, humidity information, yellow dust information, sunrise time information, and sunset time information) pre-selected through the user interface, and thus, may increase efficiency for generating data. Furthermore, additionally needed data may be described in a ‘weather’ item and may thus be capable of being input. Also, a check box may select whether to generate data through a text input and may enable a single input of text or selections of a still image, a moving image, and a plurality of inputs. That is, the user interface may provide the check box which enables a user to select item-based input information, associated with the weather environment information and the climate environment information, and input information among a text, a still image, and a moving image.

Based on sunset and sunrise time information among input items, the generative AI model may obtain information about backlight or reflection through a position of sun corresponding to a corresponding time. The kind of rain may be selected as heavy rain or heavy snow, and a simultaneous selection may be possible. Under such a special situation, a load (for example, heavy rain (3): heavy snow (7)) of heavy rain and heavy snow may be input to the ‘weather’ item, and thus, the generative AI model may obtain detailed data.

FIG. 7 illustrates an example of a method of inputting a still image and a moving image to a weather and climate environment generating module for generating a weather and climate environment.

In FIG. 7, a still image and moving image input method for generating a weather environment and generating a climate environment is illustrated. To reproduce a desired simulation environment, information may be input to a weather and climate environment generating module by using still image and moving image information about a similar environment. A user may input an explanation (text information) of an environment corresponding to a simulation environment and the still image and moving image information, and thus, desired weather and climate environment data may be generated. Also, in a case where information about a weather situation is stored together simultaneously with obtaining still image and moving image data, when the still image and moving image information is used through call when being input to a generating model, data may be generated without needing separate explanation.

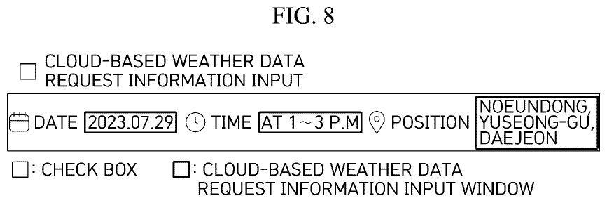

FIG. 8 illustrates an example of a method of inputting a cloud-based weather information request to a weather and climate environment generating module for generating a weather and climate environment.

In FIG. 8, an example which requests weather information from a cloud so as to generate a weather and climate environment is illustrated. In the weather data server 300 storing past weather and climate information, as in FIG. 8, when date, time, and place information are input, received weather and climate information may be input to a generative model, based on information input through a cloud service, and a weather and climate environment generating module (111 of FIG. 5) may generate weather and climate data of a requested time and place, based on the received weather and climate information.

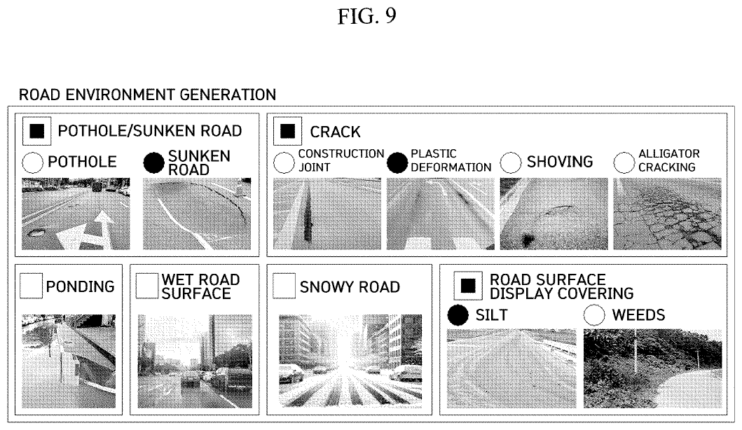

FIG. 9 illustrates an example of a method of inputting an image to a road environment generating module for generating an environment.

Referring to FIG. 9, an example is illustrated where a user inputs an image for generating a road environment by using the road environment generating module 112. Based thereon, an environment of a road changed by a breakage status of a road caused by traffic, climate, and the other factors may be generated. The road environment generating module 112 may be configured to input a size, a depth, and a shape as a status such as a pothole and a sunken road in detail, and moreover, may be configured to set a shape and a range and generate various kinds of cracks. Also, the road environment generating module 112 may generate an environment such as a status of a wet road surface in a fine weather environment after it rains or snows or a snow-piled status, and a snowy state and may generate a road environment where a road surface is covered by weeds near a road or foreign materials caused by a clear snow vehicle and silt dropped onto a road caused by construction and a vehicle which drives on an unpaved road, and thus, an unformed road environment may be generated, thereby enabling the test and verification of an autonomous driving system in various environments. Also, the road environment generating module 112 may receive an average traffic and years of a road and may generate a deteriorated road environment based thereon.

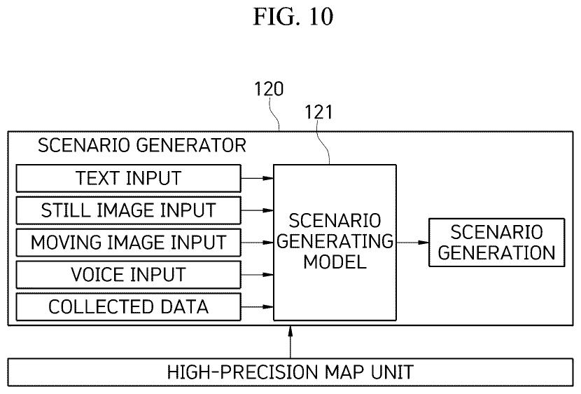

FIG. 10 illustrates a configuration of a scenario generator 120.

Referring to FIG. 10, the scenario generator 120 may provide various traffic situations and a change in traffic situation, which may be confronted with an autonomous driving vehicle in a real road environment. Therefore, the function and performance verification of an autonomous driving system may be easy, and the safety of a system on an unexpected situation or a risk factor may be secured.

The scenario generator 120 may include a scenario generating model 121. The illustrated elements may not be essential, and thus, a scenario generator including more elements or fewer elements may be implemented. Such an element may be implemented with hardware or software, or may be implemented by a combination of hardware and software.

The scenario generating model 121 may generate a scenario such as a traffic change of a vehicle and a pedestrian, an instant weather change, and an accident situation on a map, based on a text input, a still image input, a moving image input, a voice input, and a complex input of collected data, and a high-precision map. Also, by using the scenario generating model 121, various complicated scenarios may be implemented compared to a scenario generating method used in a conventional simulator. The conventional scenario generating method may need more time and efforts as a scenario is generated to be more diversified and complicated, and scenario correction may not be easy, but a scenario generating method performed by the scenario generating model 121 according to an embodiment of the present disclosure may simulate more situations which may occur in a driving situation, based on an input method.

As an example of a text input method, there may be ‘generating a scenario where an autonomous driving vehicle passe through a pedestrian crossing having no traffic light in an unprotected crossing’, ‘generating a scenario where an autonomous driving vehicle stops due to a pedestrian when the autonomous driving vehicle turns right in a signal intersection, and thus, enables the pedestrian to pass’, and ‘generating a scenario where an autonomous driving vehicle avoids an obstacle in a situation where a road is slippery due to sudden rain (rainfall: 15 mm/h)’. Here, a position, a zone, and a range where an event occurs may be set to a global position or node/link information about the high-precision map unit 150 in a virtual environment.

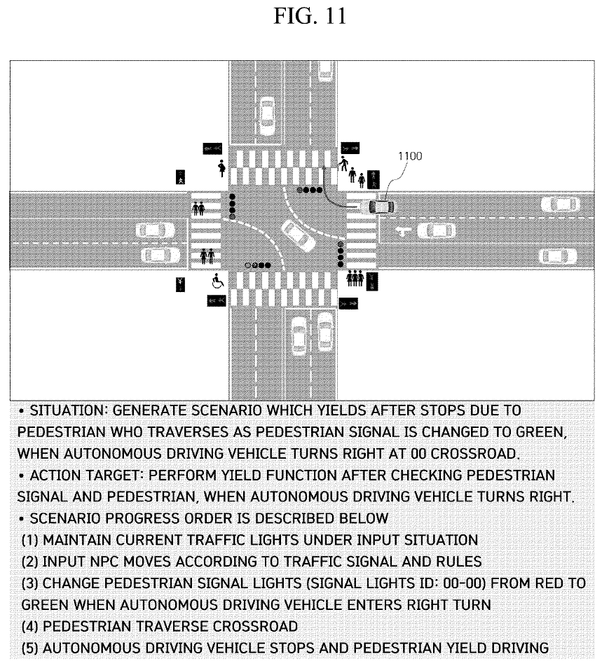

Hereinafter, an example of various scenario generating methods performed by the scenario generator 120 will be described with reference to FIGS. 11 to 13.

FIG. 11 illustrates an example of generating a scenario through a map-based text input.

FIG. 11 illustrates an example of a screen of a map-based scenario editor, and a user may set several non-player characters (NPCs) on a high-precision map and a virtual environment, and then, may input, as a text, an action/movement associated with an NPC to generate a scenario. The user may set, as input items, situation explanation, an event to occur, an action target of an autonomous driving vehicle 1100, and a constraint condition to finish a module.

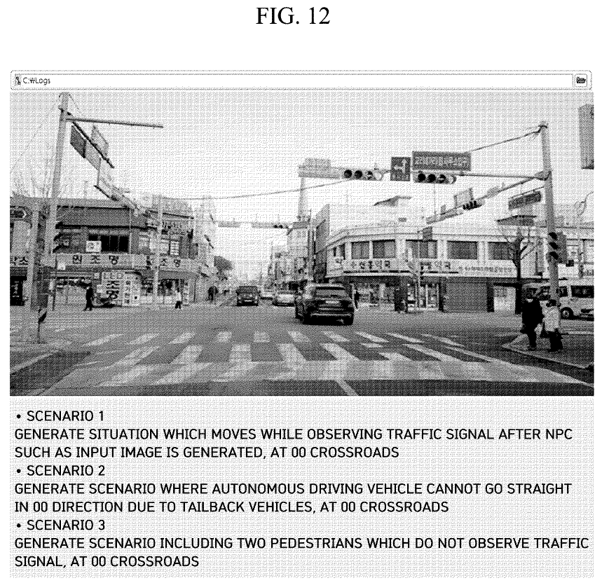

FIG. 12 illustrates an example of generating a scenario through an image and text input.

FIG. 12 illustrates an example which inputs a scenario as a text along with a crossroad image in pre-stored crossroad information to generate a scenario which is to be verified. The scenario generator 120 may reflect a scenario in an image, based on an input text.

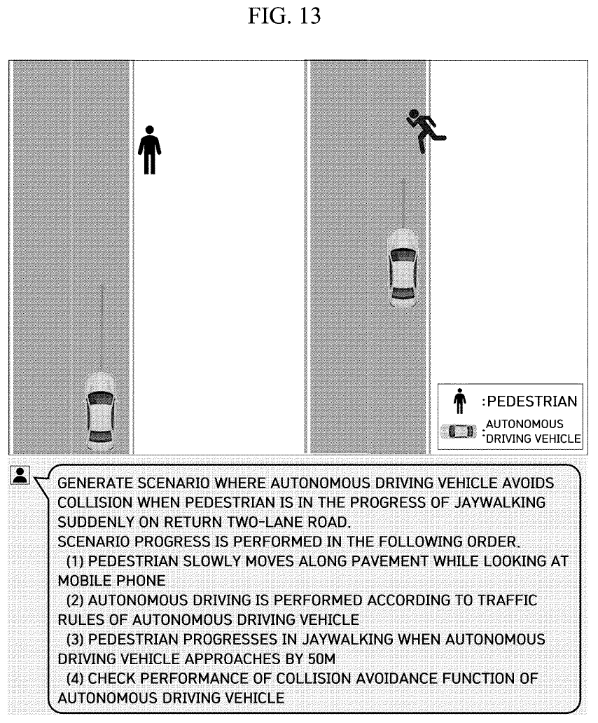

FIG. 13 illustrates an example of generating a scenario through a voice input.

FIG. 13 illustrates an example of a screen of a voice-based scenario editor, and a user may simply input a scenario as a voice. An illustrated example illustrates an example which inputs, as a voice, a scenario where an autonomous driving vehicle avoids a collision and a progress order of the scenario in detail, when a pedestrian is suddenly jaywalking in front of the autonomous driving vehicle on a return two-lane road. When the user inputs a scenario as a voice, a recognized voice may be output to a lower end of the scenario editor.

Moreover, the user may input collected driving data and driving environment data, obtained in the middle of autonomous driving, to the scenario generator 120 and may thus generate a scenario which may realistically simulate a situation where autonomous driving is difficult or a situation where autonomous driving fails. Also, the scenario generator 120 may verify the function and performance of an autonomous driving system in a situation where it is difficult to reproduce in a real road environment through generating of a scenario such as the occurrence of traffic accident, emergency vehicle yield, and luggage drop.

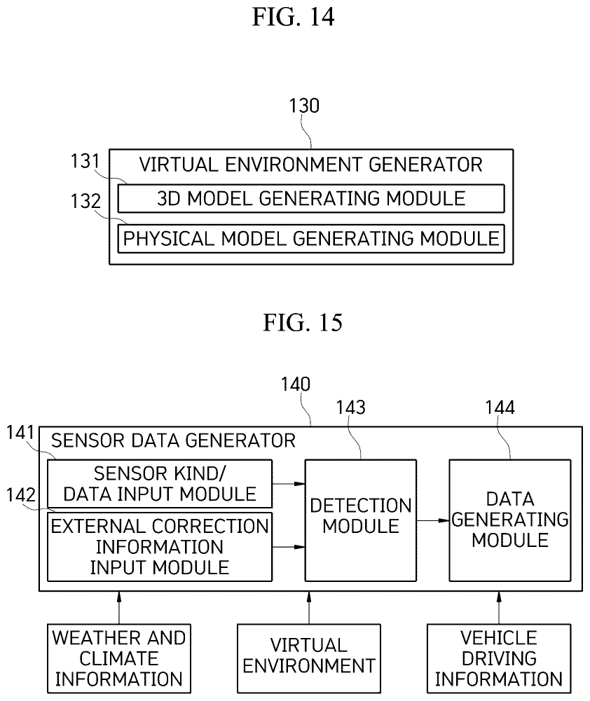

FIG. 14 illustrates a configuration of a virtual environment generator 130.

The virtual environment generator 130 may generate an environment similar to a real environment such as center of city, suburb, expressway, unformed road, and weather, and thus, may enable various tests and verifications of an autonomous driving vehicle to be performed in a driving environment such as a real environment.

Referring to FIG. 14, the virtual environment generator 130 may include a three-dimensional (3D) model generating module 131 and a physical model generating model 132. The illustrated elements may not be essential, and thus, a virtual environment generator including more elements or fewer elements may be implemented. Such an element may be implemented with hardware or software, or may be implemented by a combination of hardware and software.

In an embodiment, a driving environment and a scenario generated by using a generative AI model may be applied to a conventional virtual environment, and thus, a 3D model and a physical model may be generated by using information obtained from a sensor (LiDAR, camera, radar, IMU, etc.) of an autonomous driving vehicle.

The 3D model generating module 131 may perform shaping and visualization through a 3D model design, based on weather and climate environment information and road environment information input from a driving environment generator (110 of FIG. 4), and particularly, may apply a road attribute by using map data in an environment where a road structure such as a construction section is changed. Also, the 3D model generating module 131 may generate a model through shaping and visualization of a factor needed for a scenario, based on information input from a scenario generator (120 of FIG. 4). That is, the 3D model generating module 131 may perform shaping and visualization of a virtual environment, based on information about a driving environment and information about a scenario.

The physical model generating module 132 may apply physical factors such as a collision, a friction, and an acceleration to a model three-dimensionally generated by the 3D model generating module 131. For example, characteristics such as the absorption and scattering of light and a collision with an object may be applied to raindrop, fog, and snow, and thus, the physical model generating module 132 may allow the three-dimensionally generated model to perform a physical interaction with each other or a peripheral environment and may simulate a situation where a behavior of a vehicle is changed due to a physical factor such as a friction coefficient of a wet road surface or the shape and intensity of a road crack.

FIG. 15 illustrates a configuration of a sensor data generator.

Examples of a sensor of an autonomous driving vehicle may include a camera, LiDAR, a radar, an IMU, and a GPS. Output data of a LiDAR sensor may include 3D position coordinates and intensity information. Here, intensity may be reflection intensity information which is measured when a laser irradiated by the LiDAR sensor is reflected by an object and returns and may represent the degree of laser reflection by a detected object, and a value thereof may vary based on a material, a surface status, a distance, a reflection angle, and an environmental factor of the object. Particularly, a bad weather environment may scatter or absorb a laser signal of the LiDAR sensor to decrease intensity, and an intensity value thereof may vary even when strong sunlight or peripheral illumination interferes in the laser signal.

The LiDAR sensor may provide a distance, a velocity, a direction, and signal intensity information and may be less affected by a bad weather environment than other sensors, but signal intensity may decrease based on the amount thereof.

The camera sensor may output image data including an RGB value and may be vulnerable to bad weather and peripheral illumination, and a multipath and a reflection problem may occur.

Moreover, there may be several technologies where a GPS providing position and direction information about a vehicle decreases an error and increases accuracy, but a satellite signal may have an error which occurs in an environment such as center of city, a tunnel, or a forest.

Furthermore, the IMU may be used as a posture information measurement sensor of a vehicle and may measure movement sensor data of a degree of 6 freedom, and thus, may measure information associated with a posture and a direction of a vehicle in the middle of driving.

Sensor information generated by conventional simulation equipment may not reflect a real environment and may not process a dynamic factor based on a movement of a vehicle. However, the sensor data generator 140 according to an embodiment may perform a function of reinforcing output data of each sensor by using generative AI technology so as to overcome a limitation of conventional technology. Data based on a scenario and a driving environment of a virtual environment may be generated through a model which has been trained on various environments.

Referring to FIG. 15, the sensor data generator 140 may be configured to include a sensor kind/data input module 141, an external correction information input module 142, a detection module 143, and a data generating module 144. The illustrated elements may not be essential, and thus, a sensor data generator including more elements or fewer elements may be implemented. Such an element may be implemented with hardware or software, or may be implemented by a combination of hardware and software.

Because a sensor used for each autonomous driving system differs, the sensor kind/data input module 141 may determine and receive the kind of sensor used based thereon and may receive the spec of the input sensor.

The external correction information input module 142 may be a module which adjusts a distance value apart from a reference point such as a centroid of a vehicle or a GPS installation position through an information input for external correction, based on position information about a sensor equipped in a real autonomous driving vehicle corresponding to a simulation vehicle unit. Based on the module, a user may correct a position of a sensor, based on an installation position of a sensor in a real vehicle and a size of the real vehicle for each autonomous driving vehicle to which a simulation is to be applied. When the kind of autonomous driving vehicle is selected, the external correction information input module 142 may adjust positions of sensors to be suitable for the selected autonomous driving vehicle, based on a sensor position database previously input for each autonomous driving vehicle.

The detection module 143 may detect sensing data which may be sensed in a simulation environment by using sensors input based on a virtual environment. The data generating module 144 may generate corresponding raw sensor data for each sensor, based on sensing data of each sensor detected by the detection module 143. In this case, the data generating module 144 may output more accurate data, based on weather and climate information, and may apply a physical interaction to the sensing data to generate raw sensor data, based on vehicle driving information such as velocity, acceleration, and turn information about a vehicle.

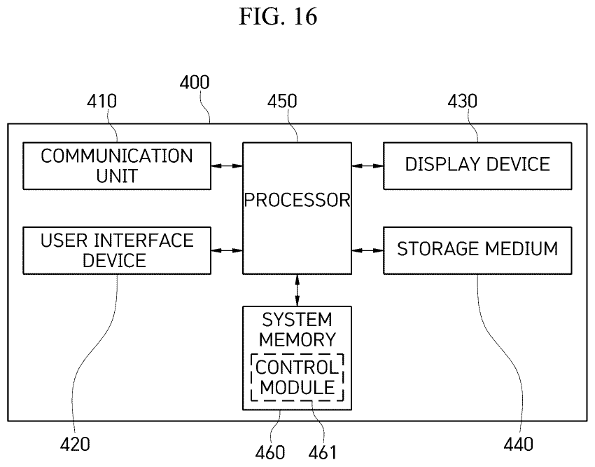

FIG. 16 is a block diagram illustrating a generative AI-based autonomous driving simulation apparatus 400 according to an embodiment of the present disclosure.

Referring to FIG. 16, the generative AI-based autonomous driving simulation apparatus 400 may include a communication unit 410, a user interface device 420, a display device 430, a storage medium 440, a processor 450, and a system memory 460.

The communication unit 410 may transmit and receive signals between the generative AI-based autonomous driving simulation apparatus 400 and an external weather data server (300 of FIG. 4) or external devices over a network.

The user interface device 420 may receive a user input for controlling operations of the generative AI-based autonomous driving simulation apparatus 400 or the processor 450. The user interface device 420 may include a keypad, a dome switch, a touch pad (pressure sensitive/capacitive), a jog wheel, a jog switch, and a finger mouse.

The display device 430 may operate in response to control by the processor 450. The display device 430 may display information processed by the generative AI-based autonomous driving simulation apparatus 400 or the processor 450. For example, the display device 430 may display an image, based on control by the processor 450.

The storage medium 440 may be at least one of flash memory, hard disk, solid state disk type (SSD), multimedia card memory, random access memory (RAM), static random access memory (SRAM), read-only memory (ROM), electrically erasable programmable read-only memory (EEPROM), programmable read-only memory (PROM), a magnetic memory, a magnetic disk, and an optical disk. The storage medium 440 may be configured to write or read data in response to control by the processor 450.

The processor 450 may include one of general-purpose or dedicated processors and may control operations of the communication unit 410, the user interface device 420, the display device 430, the storage medium 440, and the system memory 460.

The processor 450 may be configured to load program codes, including instructions providing various functions when executed, from the storage medium 440 into the system memory 460 and execute the loaded program codes. The processor 450 may load a control module 461, including the instructions and/or the program codes, from the storage medium 440 into the system memory 460 and may execute the loaded control module 461. The control module 461 may display a text, an image, and/or a video input from a user by using the display device 430 and may sense a related user input. Also, the control module 461 may visualize an additional user interface in the display device 430 and may sense a user input, based thereon.

The processor 450 may implement all functions of the generative AI-based autonomous driving simulation apparatus 400 and all processes of a control method by the generative AI-based autonomous driving simulation apparatus 400 described above with reference to FIG. 4, based on a program loaded through the control module 461 or from the storage medium 440.

The system memory 460 may be provided as a working memory of the processor 450. In the drawing, the system memory 460 is illustrated as an element separated from the processor 450, but this may be an embodiment and at least a portion of the system memory 460 may be integrated into the processor 450. The system memory 460 may include at least one of random access memory (RAM), read only memory (ROM), and storage mediums readable by computers of other types.

The embodiments described above may be that the elements and features of the present disclosure are combined in a certain form. Unless separately and explicitly described, each element or feature should be considered to be selective. Each element or feature may be implemented in a form which is not combined with another element or feature. Also, the embodiment of the present disclosure may be configured by combining some elements and/or features with each other. The order of operations described in the embodiments of the present disclosure may be changed. Some elements or features of a certain embodiment may be included in another embodiment, or may be replaced with an element or a feature corresponding to another embodiment. In Claim, it is obvious that an embodiment may be configured by combining claims having no explicit citation relationship, or may be included as a new claim by correction after patent application.

The embodiments according to the present disclosure may be implemented by various means (for example, hardware, firmware, software, or a combination thereof). In implementation based on hardware, an embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, and microprocessors.

In implementation based on firmware or software, the embodiments of the present disclosure may be implemented in a form such as a module, a process, or a function, which performs functions or operations described above. A software code may be stored in a memory and may be driven by a processor. The memory may be disposed in or outside the processor and may transfer or receive data to or from the processor, based on various means known to those of ordinary skill in the art.

Embodiments of the present disclosure provides a method which may construct a generative model through learning on various road environments, weather and climate conditions, and driving situations by using generative AI technology and may generate a physical virtual environment, based on text and image information input based on the model.

Moreover, embodiments of the present disclosure may implement raw sensor data of a sensor from a generated virtual environment by using AI technology and may generate various complicated scenarios to secure the performance enhancement and reliability of an autonomous driving system.

Moreover, embodiments of the present disclosure may reduce time and cost for generating a simulation environment, may simulate various driving environments such as weather and climate environments and road environments to be similar to a real environment so as to enable a physical interaction, and may provide sensor data similar to data detected from the real environment, and thus, may expect to enhance a recognition function and may provide a scenario of various driving situations in various complicated environments by using AI technology, thereby increasing the performance and driving-enabled area of an autonomous driving vehicle.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A generative artificial intelligence (AI)-based autonomous driving simulation apparatus comprising:
a driving environment generator configured to generate a driving environment by using a pre-learned driving environment generating model, based on input driving environment information;
a scenario generator configured to generate a scenario representing a change in the driving environment and an action of an object on a road over time by using a pre-learned scenario generating model, based on input scenario information;
a virtual environment generator configured to visually and physically model the driving environment and the scenario to generate a virtual environment, based on the driving environment, the scenario, and a high-precision map;
a simulation vehicle unit configured to drive in the virtual environment and generate vehicle driving information, based on a driving control signal;
a sensor data generator configured to generate raw sensor data detected by a recognition sensor of the simulation vehicle unit in the virtual environment; and
an autonomous driving system configured to generate the driving control signal to control driving of the simulation vehicle unit in the virtual environment, based on the raw sensor data and the vehicle driving information.

2. The generative AI-based autonomous driving simulation apparatus of claim 1, wherein the driving environment generator comprises a weather and climate environment generating module and a road environment generating module,
the weather and climate environment generating module generates a weather/climate environment, based on a text and an image input through a pre-learned weather/climate generating model corresponding to the driving environment generating model or weather data received from a weather data server,
the road environment generating module generates a road environment, based on a text and an image input through a pre-learned road environment generating model corresponding to the driving environment generating model, and
the driving environment comprises the weather/climate environment and the road environment.

3. The generative AI-based autonomous driving simulation apparatus of claim 1, wherein the scenario information comprises a text, an image, a voice, and collected data, and
the scenario generating model is a generative AI model trained to generate the scenario, based on the scenario information and the high-precision map.

4. The generative AI-based autonomous driving simulation apparatus of claim 1, wherein the virtual environment generator comprises a three-dimensional (3D) model generating module and a physical model generating module,
the 3D model generating module visually models the virtual environment, based on the driving environment and the scenario, and
the physical model generating module applies a physical factor to a model of the virtual environment visually modeled by the 3D model generating module.

5. The generative AI-based autonomous driving simulation apparatus of claim 1, wherein the sensor data generator comprises a sensor kind/data input module, a detection module, and a data generating module,
the sensor kind/data input module receives a kind of recognition sensor used in the autonomous driving system and receives a spec of the received recognition sensor,
the detection module detects sensing data capable of being sensed by the recognition sensor in the virtual environment, based on the kind of recognition sensor and spec information input through the sensor kind/data input module, and
the data generating module generates corresponding raw sensor data for each sensor, based on the sensing data of the recognition sensor detected by the detection module.

6. The generative AI-based autonomous driving simulation apparatus of claim 5, wherein the sensor data generator further comprises an external correction information input module, and
the external correction information input module adjusts a distance value apart from a reference point of an autonomous driving vehicle corresponding to the simulation vehicle unit, based on position information about a sensor equipped in the simulation vehicle unit.

7. The generative AI-based autonomous driving simulation apparatus of claim 6, wherein the external correction information input module adjusts a position of the recognition sensor for each of selected autonomous driving vehicles, based on a sensor position database for each autonomous driving vehicle.

8. The generative AI-based autonomous driving simulation apparatus of claim 5, wherein the data generating module applies a physical interaction to the sensing data in the virtual environment to generate the raw sensor data, based on the weather/climate environment and the vehicle driving information.

9. The generative AI-based autonomous driving simulation apparatus of claim 1, wherein the driving environment information and the scenario information comprise text and image information, and
the driving environment generating model and the scenario generating model comprise a generative AI model trained to respectively generate the driving environment and the scenario, based on the driving environment information and the scenario information.

10. The generative AI-based autonomous driving simulation apparatus of claim 2, wherein the weather and climate environment generating module provides a first user interface for an input of each of weather environment information and climate environment information, and
the first user interface provides selection item information of input information among item-based input information, a text, a still image, and a moving image associated with the weather environment information and the climate environment information.

11. The generative AI-based autonomous driving simulation apparatus of claim 2, wherein the weather and climate environment generating module:
provides a second user interface for an input of information requesting weather information from a cloud,
receives weather and climate information about a place corresponding to information input from the weather data server when specific date, time, and place information are input to the second user interface, and
generates the weather/climate environment through the weather/climate generating model, based on weather and climate information about a place corresponding to information input from the weather data server.

12. The generative AI-based autonomous driving simulation apparatus of claim 2, wherein the road environment generating module generates a road environment in which an input road status is reflected, based on an image of the road status and a text describing the input road status.

13. The generative AI-based autonomous driving simulation apparatus of claim 2, wherein the road environment generating module generates a road environment in which a degree of deterioration of a road is reflected, based on a text corresponding to information about years of the road and average traffic input thereto.

14. A generative artificial intelligence (AI)-based autonomous driving simulation apparatus comprising:
a memory configured to store one or more instructions; and
a processor configured to execute the one or more instructions,
wherein, when a corresponding instruction is executed, the processor:
generates a driving environment by using a pre-learned driving environment generating model, based on input driving environment information,
generates a scenario representing a change in the driving environment and an action of an object on a road over time by using a pre-learned scenario generating model, based on input scenario information,
visually and physically models the driving environment and the scenario to generate a virtual environment, based on the driving environment, the scenario, and a high-precision map,
generates vehicle driving information while driving in the virtual environment, based on a driving control signal,
generates raw sensor data detected by a recognition sensor of the simulation vehicle unit in the virtual environment, and
generates the driving control signal to control driving of the simulation vehicle unit in the virtual environment, based on the raw sensor data and the vehicle driving information.

15. The generative AI-based autonomous driving simulation apparatus of claim 14, wherein the processor:
executes a weather and climate environment generating module to generate a weather/climate environment, based on a text and an image input through a pre-learned weather/climate generating model corresponding to the driving environment generating model or weather data received from a weather data server, and
executes a road environment generating module to generate a road environment, based on a text and an image input through a pre-learned road environment generating model corresponding to the driving environment generating model, and
the driving environment comprises the weather/climate environment and the road environment.

16. The generative AI-based autonomous driving simulation apparatus of claim 14, wherein the scenario information comprises a text, an image, a voice, and collected data, and
the scenario generating model is a generative AI model trained to generate the scenario, based on the scenario information and the high-precision map.

17. The generative AI-based autonomous driving simulation apparatus of claim 14, wherein the processor:
executes a three-dimensional (3D) model generating module to visually model the virtual environment, based on the driving environment and the scenario, and
executes a physical model generating module to apply a physical factor to a model of the virtual environment visually modeled by the 3D model generating module.

18. The generative AI-based autonomous driving simulation apparatus of claim 14, wherein the processor:
executes a sensor kind/data input module to receive a kind of recognition sensor used in the autonomous driving system and receive a spec of the received recognition sensor,
executes a detection module to detect sensing data capable of being sensed by the recognition sensor in the virtual environment, based on the kind of recognition sensor and spec information input through the sensor kind/data input module, and
executes a data generating module to generate corresponding raw sensor data for each sensor, based on the sensing data of the recognition sensor detected by the detection module.

19. The generative AI-based autonomous driving simulation apparatus of claim 18, wherein the processor executes an external correction information input module to adjust a distance value apart from a reference point of an autonomous driving vehicle corresponding to the simulation vehicle unit, based on position information about a sensor equipped in the simulation vehicle unit.

20. The generative AI-based autonomous driving simulation apparatus of claim 14, wherein the driving environment information and the scenario information comprise text and image information, and
the driving environment generating model and the scenario generating model comprise a generative AI model trained to respectively generate the driving environment and the scenario, based on the driving environment information and the scenario information.
